(19) United States
(12) Patent Application Publication
(10) Pub. No.: US 2006/0108454 A1
(43) Pub. Date: May 25, 2006

(54) Spraying device for spraying an operating liquid

(76) Inventor: Heinz-Dieter Eichholz, Iserlohn (DE)

Correspondence Address: William D. Breneman, Esq.;BRENEMAN & GEORGES, 3150 Commonwealth Avenue, Alexandria, VA, 22305, US

(21) Appl. No.: 11/270,618

(22) Filed: Nov. 10, 2005

(30) Foreign Application Priority Data
Nov. 12, 2004 (DE) 10 2004 054 877.3
Mar. 18, 2005 (DE) 10 2005 013 127.1

(51) Int. Cl. A62C 37/20

(52) U.S. Cl. 239/562; 239/589; 239/591; 239/550; 239/551

(57) ABSTRACT

The present invention suggests a spraying device for spraying an operating liquid of a dishwasher or a washing machine where said spraying device has at least one spray nozzle comprising a spraying opening for generating a spray jet of the operating liquid. Said spraying device is an improvement of similar devices known from prior art. This is achieved according to the present invention by providing at least one adjusting mechanism for changing the spray characteristics.

The present invention relates to a spraying device for spraying an operating liquid of a dishwasher or a washing machine according to the preamble of the main claim 1.

In dishwashers, mainly rotating spray arms are used that spray water with or without cleaning agents, rinsing agents and the like or washing water out of the dishwasher sump in the interior of the machine.

The spray arms are manufactured using thermoplastic or metal. The thermoplastic designs are blow-molded parts and/or injection-molded parts whereby generally two shell-shaped parts are welded or connected to one another using a material-fitting. Metallic versions are usually manufactured using bending parts/stamped parts or deep-drawn parts by cranking two parts of the housing.

What is common to all these embodiments is that the nozzles are designed as simple holes or boreholes of the spray arm. The spray arm thus represents a stationary, unchanging hydraulic resistance in the entire circulation circuit of the machine. Due to this a fixed spray pattern is created where an almost constant rotation speed of the spray arm is present.

For example, the circulation circuit of a dishwasher contains, in particular, a pump, the machine base as a catchment tank for the sprayed liquid, a line system having a distributor, ramifications and e.g. shift valves and a control unit for controlling or regulating the rinsing process. Usually an upper and a lower spray arm are alternately impinged with liquid.

A spray arm, two of which are usually present in a modern dishwasher, comprises several nozzles. At least one nozzle is designed in such a way that the spray arm is driven or set into rotation by a backstroke effect of the outflowing liquid, whereby cleaning agents and the like are simultaneously sprayed in part from the dosing device. Additional nozzles are designed in such a way that they create an essentially vertically oriented spray jet and thus spray at the cleaning item or the dishes. An oblique orientation of the spray jet results due to the rotation of the spray arm.

The disadvantage of the spraying devices known from prior art is particularly that the same orientation and strength of the spray jet is present during the entire cleaning or rinsing process and thus the liquid is sprayed at the dishes in the same manner. This leads, among other things, to the soiled areas being sprayed at from the same direction. Furthermore, particularly when containers such as cups, bowls, pots and the like are incorrectly stacked in the dishwasher, there are regions that are not sprayed at directly by the spray jet since for example, the oblique jet can never directly spray at surfaces that are oriented opposite to the direction of rotation.

Therefore, the objective of the present invention is to suggest a spraying device for spraying an operating liquid of a dishwasher or a washing machine where said spraying device has at least one spray nozzle comprising a spraying opening for generating a spray jet of the operating liquid where said spraying device is an improvement of similar devices known from prior art.

Based on the spraying devices known from prior art of the afore-mentioned kind, this objective is achieved by the characteristic features of the main claim 1. The measures mentioned in the dependent claims enable advantageous embodiments and configurations of the present invention.

Accordingly a spraying device according to the present invention is characterized by the fact that at least one adjusting mechanism is provided for changing the spray characteristics. Using this measure it is possible to achieve a spray pattern that can change during the rinsing process or the cleaning process. This leads to a change in the manner in which the items to be cleaned are spotlighted, which in turn signifies a variable force effect on the dirt and the like. A force effect that changes advantageously can improve the cleaning action.

According to the present invention, the direction of rotation or the direction of movement of a spray arm and the like can be changed or reversed and/or the soiled areas are alternately spotlighted using spray jets oriented in the opposite direction and the dirt can thus be moved ‘back and forth.’ It is thus possible to count on a markedly improved cleaning action.

The adjusting mechanism is advantageously designed for changing the cross-section of the spraying opening. Due to this it is possible to change particularly the strength or the throughflow quantity of the liquid through the nozzle in an advantageous way. This can lead to an improved cleaning action.

In addition, in case of several spray nozzles, individual spray nozzles can comprise cross-sections that change advantageously especially in certain operational phases. This leads to a perfectly novel spray characteristic that differs according to the various operational phases.

For example, it is possible to implement a point-symmetrical or a mirror-symmetrical or an asymmetrical change of the cross-section. The orientation of the spray jet cannot be changed or can be changed in a particularly targeted manner depending on the change in the cross-section.

In an advantageous version of the present invention, the adjusting mechanism is designed for changing the direction of the spray jet. As stated earlier, this can take place for example, by advantageously changing the cross-section. It is possible to change the position and/or orientation of a section containing the spray nozzle(s), e.g. of a spray arm and the like. It is especially possible to rotate said section around its longitudinal axis.

If necessary, a holding unit of the spray nozzle contains the adjusting mechanism. The spray nozzle is advantageously arranged and/or fixed on a rotatable spray arm and the like with the help of the holding unit. The direction of the spray jet can be changed, for example, by adjusting the spray nozzle with respect to the spray arm and the like. The holding unit possibly comprises at least one axis of rotation and/or a Cardan joint and the like for twisting the spray nozzle.

The adjusting mechanism is advantageously designed for changing the cross-section of the spraying opening and for changing the direction of the spray jet. This enables the implementation of a particularly flexible and/or extensive change in the rinse characteristic according to the present invention.

In advantageous embodiments of the present invention, the adjusting mechanism contains at least one first adjusting liquid for hydraulically changing the cross-section of the spraying opening and/or the adjusting mechanism contains at least one second and/or the first adjusting liquid for hydraulically changing the direction of the spray jet. An appropriate hydraulic liquid can be advantageously brought to the location of the nozzles in order to generate the corresponding change.

The operating liquid is designed as the first adjusting liquid and/or the second adjusting liquid. Using this measure, it is possible to implement the adjustment and/or change in a particularly easy manner. For example, the cross-section and/or the spray jet direction of the spray nozzle is changed by a variation of or by using varying pressures of the operating liquid or the adjusting liquid.

Basically, it is possible to implement a continuous and/or gradual change of the cross-section and/or of the spray jet direction of the spray nozzle and/or of the pressure of the operating liquid or adjusting liquid.

The adjusting mechanism advantageously comprises at least one fixing device for locating the cross-section of the spraying opening and/or the direction of the spray jet. Thus it is possible to realize a gradual change of the cross-section and/or the spray jet direction of the spray nozzle. Furthermore, it is thus possible to achieve a maximum cross-section and/or a maximum deflection of the spray jet.

The spray nozzle preferably comprises a first section that is non-adjustable particularly with respect to the spray arm and the like and a second section that is adjustable with respect to the spray arm. For example, the non-adjustable first section is fixedly arranged on the spray arm and the like. Among other things, the spray nozzle can be detachably connected to the spray arm and the like, e.g. the spray nozzle can be buttoned in, inserted, snapped into position, bonded, etc. The spray nozzle can also be connected to the spray arm and the like using a material-fitting, e.g. the spray nozzle can be welded or soldered in.

In this variant, the second section of the spray nozzle is designed to be displaceable and/or adjustable as opposed to the first section so that it is possible to advantageously implement a change in the jet direction.

The fixing device is designed preferably as a stop of the adjustable second section of the spray nozzle. A stop can be implemented particularly easily. For example, the spray nozzle and the spray arm and the like each comprise a contact surface that are at a distance from one another at least in one position of the spray nozzle while they come into contact with one another in another position of the spray nozzle. Thus it is possible to determine the cross-section of the spraying opening and/or the direction of the spray jet at least in part.

For example, a clear cross-section of the rinsing opening is provided in the idle position of the rinse nozzle. If necessary, this clear cross-section can be used as a first operation step of the nozzle. Here, for example, up to an adjustable pressure of the operating liquid or the adjusting liquid and/or at a certain time-point and/or during a certain period of time that can be determined by means of a control unit or the like, the cross-section does not exhibit any important change. The rinse characteristics according to the present invention can change beyond an adjustable pressure and/or beyond a certain time-point and/or during a certain period of time. Thus it is possible to easily implement an at least two-stage embodiment of the feasible rinse characteristics.

The spraying opening of the spray nozzle is essentially closed in the idle position. Due to this, it is possible to achieve particularly low flow rates, for example in case of low pressures of the operating liquid or the adjusting liquid.

If necessary, the adjusting mechanism comprises at least one axis of rotation, a hinge, a lever mechanism, etc. for changing the spray characteristics. Preferably, the spray nozzle is elastically deformable at least in part. Using this measure it is possible to carry out a particularly simple adjustment according to the present invention. For example, the spray nozzle is designed to be elastically deformable at least in the region of the second section and/or between the first and the second section. For example, the spray nozzle is designed as a lip valve and the like.

In general, by using a spray nozzle that is elastically deformable at least in part, it is possible to carry out a particularly simple resetting especially in the idle position. Due to this, the spray nozzle can be manufactured cost-effectively and with a simple design.

The spray nozzle is essentially designed as an elastomer component. Thus it is possible to advantageously implement a spray nozzle that contains only one material and that can be easily adjusted according to the present invention. For example, a spray nozzle can be manufactured out of (liquid) silicon. This can take place by means of the injection-molding process. Here, almost any shapes and contours of the spray nozzle are feasible.

It is generally advantageous to provide the spray nozzle with an inner contour that is at least partly conical or narrow. Thus it is possible to advantageously configure and change the spray jet. Here a radial force component can be generated onto the spray nozzle due to which it is possible to expand the cross-section of the spraying opening particularly in case of a spray nozzle that is deformable at least in part. Basically, when using several spray nozzles, each of the spray nozzles used can comprise any shape or a different shape and/or inner contour.

In a preferred version of the present invention, the spraying device contains at least one rotating spray arm where the spray nozzle is fixed on the spray arm. It is possible to resort to spray arms that are already commercially available. If necessary, the boreholes or holes that are expanded where necessary in the commercially available spray arms can be used as holders for separate spray nozzles according to the present invention.

Basically, with the help of the present invention, it is possible to create variable hydraulic resistances and additionally generate advantageous changes in the spray pattern by changing the rotation frequency of the spray arm, if necessary. This can lead to new degrees of efficiency of the cleaning action of dishwashers, in particular. In addition, it is possible to improve the disposition of spray nozzles to gather dirt by means of changing or variable cross-sections of the spraying openings.

One embodiment of the present invention is illustrated in the drawing and is explained more elaborately on the basis of the single figure.

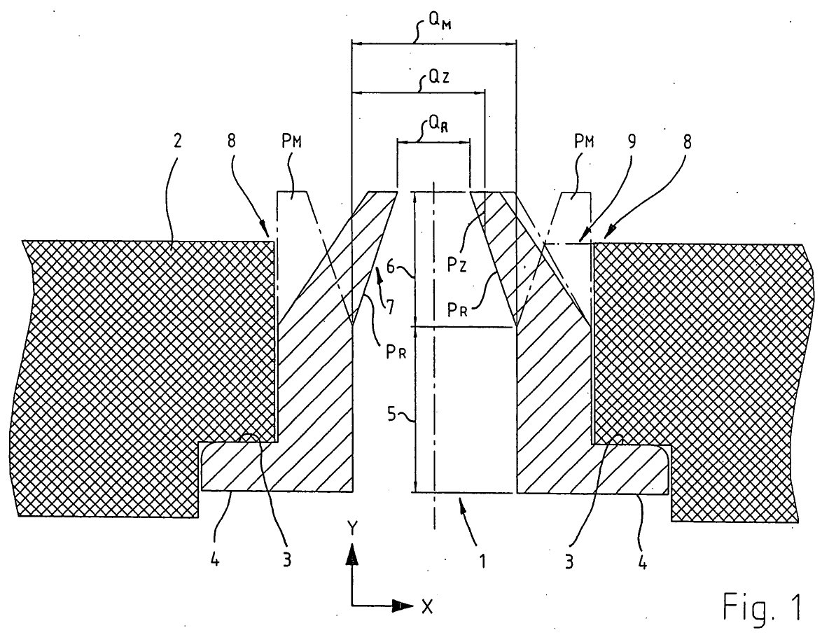

FIG. 1 schematically illustrates the section of a spray nozzle 1 according to the present invention. The spray nozzle 1 is preferably manufactured completely out of an elastomer material and is detachably affixed to a rotating spray arm 2. For example, the spray nozzle 1 is buttoned in and its projecting base area 4 hits against a wall 3 of the spray arm 2 so that outflowing liquid advantageously presses the spray nozzle 1 against the spray arm 2.

The spray arm 2 is manufactured out of thermoplastic or a metal. It is advantageously provided with a hollow form and designed for conveying the operating liquid.

The spray nozzle 1 comprises a first section 5 and a second section 6 where the first section 5 is attached such that it is stationary or non-displaceable with respect to the spray arm 2 and the second section 6 is adjustable or displaceable with respect to the spray arm 2. The second section 6 preferably comprises a taper 7 so that it can be advantageously adjusted depending on the pressure of the throughflowing liquid.

In addition, the spray nozzle 1 comprises a taper or a conical inner contour in the region of the second section 6.

As illustrated in FIG. 1, the second section in this version of the present invention is designed in such a way that a clear idle cross-section Q_{R} is achieved in the idle position P_{R}, i.e. in the state of non-application of liquid or pressure. This cross-section Q_{R} can remain unchanged e.g. essentially up to a pressure p, that can be determined by the geometry and/or the material of the second section 6. When this limit pressure p, is exceeded, the cross-section Q of the spraying opening is changed or increased to an important extent.

In a maximum position P_{M}, a maximum cross-section Q_{M} is designed. A determinable minimum pressure P_{M} of the throughflowing liquid is designed. In case of a pressure P₂ that is greater than or equal to the minimum pressure P_{M}, the cross-section of the spray nozzle 1 remains unchanged. For this purpose, a stop 8 of the spray arm 2 is provided against which the spray nozzle 1 or the adjustable second section 6 hits.

For example, the spraying opening of the spray nozzle 1 is provided with a symmetrical or round cross-section Q. It is also possible to provide a polygonal, particularly a rectangular or quadratic cross-section Q of the spraying opening or of the spray nozzle 1.

Furthermore, the borehole or the holder of the spray arm 2 for the spray nozzle 1 can comprise a round, polygonal or similar cross-section.

In general, by using the shape of the cross-section of the spray nozzle 1 and/or the holder of the spray arm 2, it is possible to change the direction of the spray jet to be generated. In order to illustrate this version, a nose 9 of the spray arm 2 is shown in a dashed form on the right side of FIG. 1. Said nose is designed as the stop for the section 6 of the spray nozzle 1. Due to this nose 9, the second section 6 cannot be adjusted to the extent that was possible in the left side of FIG. 1.

An intermediate position P₂ of the second section 6 of the right side is the maximum adjustment of the second section 6 in this region due to the nose 9. Here, an intermediate cross-section Q₂ that is not round or oval is achieved, that for example comprises a round cross-section Q_{R} in the idle position. This generates a change in the direction of the outflowing spray jet. In this example, the spray jet would consequently be deflected slightly to the left when compared to the embodiment without the nose 9.

Basically, the nozzles 1 of the spray arms 2 can be manufactured as a separate individual component or a connected elastomer component, preferable made of liquid silicon and buttoned into or inserted into the intended housing openings of the spray arms 2. Here, the elastomer nozzles 1 have an inner, preferably conical contour that produces a radial force component with a clear diameter of the nozzle 1 when static media pressure is applied. The contours of the single nozzles 1 need not be identical. Instead they can be designed individually. The holder of the nozzles 1 in the spray arm housing 2 contains additionally another contour against which the outer wall of every nozzle 1 can lean when the nozzle 1 is impinged with accordingly high pressure. Thus, in case of different operating pressures recruiting out of the circulation circuit, e.g. using pumps, change in the speed and the like, it is possible to provide at least two clear nozzle cross-sections Q that consequently lead to another individual spray characteristic in terms of flow rate, opening angle and/or orientation.

Furthermore, it is also feasible to design an elastomer nozzle that can be compared to a lip valve and that can operate such that the nozzle 1 remains closed up to a first swelling pressure, exceeding which a first clear nozzle cross-section Q is provided. Only when the second swelling pressure is exceeded, the nozzle 1 deforms elastically up to the stop 8, 9 of the outer contour achieved due to the geometry of the spray arm housing. Thus by creating variable hydraulic openings, it is possible to advantageously have several hydraulic operating points in one design and with variable piping characteristics.

What is claimed is:

1. Spraying device for spraying an operating liquid of a dishwasher or a washing machine where said spraying device has at least one spray nozzle comprising the spraying opening for generating a spray jet of the operating liquid, characterized in that at least one adjusting mechanism is provided for changing the spray characteristics.

2. Spraying device pursuant to the preamble of main claim 1, characterized in that the adjusting mechanism is designed for changing the cross-section of the spray opening.

3. Spraying device pursuant to any of the afore-mentioned claims characterized in that the adjusting mechanism is designed for changing the direction of the spray jet.

4. Spraying device pursuant to any of the afore-mentioned claims characterized in that the adjusting mechanism is designed for changing the cross-section of the spraying opening and for changing the direction of the spray jet.

5. Spraying device pursuant to any of the afore-mentioned claims characterized in that the adjusting mechanism contains at least a first adjusting liquid for hydraulically changing the cross-section of the spraying opening.

6. Spraying device pursuant to any of the afore-mentioned claims characterized in that the adjusting mechanism contains at least a second adjusting liquid for hydraulically changing the direction of the spray jet.

7. Spraying device pursuant to any of the afore-mentioned claims characterized in that the operating liquid is designed as the first adjusting liquid and/or the second adjusting liquid.

8. Spraying device pursuant to any of the afore-mentioned claims characterized in that the adjusting mechanism comprises at least one fixing device for locating the cross-section of the spraying opening and/or the direction of the spray jet.

9. Spraying device pursuant to any of the afore-mentioned claims characterized in that the spray nozzle comprises a non-adjustable first section and an adjustable second section.

10. Spraying device pursuant to any of the afore-mentioned claims characterized in that the fixing device is designed as a stop of the adjustable second section of the spray nozzle.

11. Spraying device pursuant to any of the afore-mentioned claims characterized in that the spraying opening of the spray nozzle is essentially closed in the idle position.

12. Spraying device pursuant to any of the afore-mentioned claims characterized in that the spray nozzle is elastically deformable at least in part.

13. Spraying device pursuant to any of the afore-mentioned claims characterized in that the spray nozzle is designed essentially as an elastomer component.

14. Spraying device pursuant to any of the afore-mentioned claims characterized in that the spraying device contains at least one rotatable spray arm whereby the spray nozzle is fixed on the spray arm.

15. Dishwasher or washing machine having a spraying device for spraying an operating liquid characterized in that the spraying device is designed pursuant to any of the afore-mentioned claims.
